(19) United States
(12) Patent Application Publication
(10) Pub. No.: US 2018/0334547 A1
(43) Pub. Date: Nov. 22, 2018

(54) Fluorinated Compounds Useful As Foam Expansion Agents

(71) Applicant: The Chemours Company FC, LLC, Wilmington, DE (US)

(72) Inventors: Gary Loh, Newark, DE (US); Saadat Ata, Pennsville, NJ (US)

(21) Appl. No.: 15/970,442

(22) Filed: May 3, 2018

Related U.S. Application Data
(60) Provisional application No. 62/508,746, filed on May 19, 2017.

(51) Int. Cl. C08J 9/14

(52) U.S. Cl. CPC C08J 9/146; C08J 9/149; C08J 9/141; C08J 2325/06; C08J 2355/02; C08J 2203/14; C08J 2203/144; C08J 2203/182; C08J 2205/052; C08J 2205/044; C08J 2203/164

(57) ABSTRACT

The present application discloses compositions comprising i) a foam blowing component; and ii) a polymer component, and more particularly to compositions comprising a i) foam blowing component comprising a hydrofluoroolefin (i.e., HFO), a hydrofluorocarbon (i.e., HFC), or any mixture thereof; and ii) a polymer component which is selected from polystyrene and acrylonitrile butadiene styrene.

### CROSS-REFERENCE TO RELATED APPLICATIONS

This application claims the benefit of U.S. Provisional Application Ser. No. 62/508,746, filed May 19, 2017, the disclosure of which is incorporated herein by reference in its entirety.

### TECHNICAL FIELD

This invention relates to compositions comprising a foam blowing component and a polymer component, and, more particularly to compositions comprising a foam blowing component comprising a hydrofluoroolefin (i.e., HFO), a hydrofluorocarbon (i.e., HFC), or mixtures thereof, and a polymer component which is selected from polystyrene and acrylonitrile butadiene styrene.

### BACKGROUND

The production of various types of foams historically employed chlorofluorocarbons (i.e., CFCs) as the blowing agent. In general, the CFCs yield foams exhibiting good thermal insulation, low flammability, and excellent dimensional stability. However, despite these advantages the CFCs have fallen into disfavor due to their implication in the destruction of stratospheric ozone, as well as their implication in contributing to global warming.

### SUMMARY

The present application provides, inter alia, compositions comprising:

i) a foam blowing component comprising a compound selected from (E)-1,1,1,4,4,4-hexafluoro-2-butene and 1,1,1,3,3-pentafluoropropane, or any mixture thereof; and

ii) a polymer component selected from polystyrene and acrylonitrile butadiene styrene.

The present application further provides compositions comprising:

i) a foam blowing component comprising a compound which is (Z)-1,1,1,4,4,4-hexafluoro-2-butene and a compound selected from (E)-1,1,1,4,4,4-hexafluoro-2-butene, 1,1,1,3,3-pentafluoropropane, and 1-chloro-3,3,3-trifluoropropene; and

ii) a polymer component selected from polystyrene and acrylonitrile butadiene styrene.

The compositions described herein are useful in methods of forming a foam, comprising reacting or extruding a composition provided herein under conditions effective to form a foam.

The present application further provides methods of insulating an apparatus, comprising applying a composition provided herein onto one or more surfaces of the apparatus. The present application further provides coated apparatuses, wherein the apparatus is coated with a composition provided herein.

The present application further provides polystyrene foams and acrylonitrile butadiene styrene foams which are prepared according to one or more of the methods described herein.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### DESCRIPTION OF THE DRAWINGS

FIG. 1 depicts a representative polymer sample submerged in a foam expansion agent during a compatibility analysis described in Example 1.

### DETAILED DESCRIPTION

Insulating foams such as closed-cell foams, multimodal foams, and thermoplastic foams depend on the use of blowing agents (e.g., halocarbons such as chlorofluorocarbons (CFCs) and hydrochlorofluorocarbons (HCFCs)), not only to foam the polymer, but primarily for their low vapor thermal conductivity, an important characteristic for insulation value. Polyolefin foams (e.g., polystyrene, polyethylene, and polypropylene) are widely used in insulation and packaging applications. These thermoplastic foams are generally prepared with CFC-12 (dichlorodifluoromethane) as the blowing agent and, more recently, HCFCs (HCFC-22, chlorodifluoromethane) or blends of HCFCs (HCFC-22/HCFC-142b) or HFCs (HFC-152a) have been used as blowing agents for polystyrene.

In the appliance industry, CFC-11 and HCFC-141b have been widely used as blowing agents, but recent use has been reduced by the Montreal Protocol on Substances that Deplete the Ozone Layer due to their non-zero ozone depletion potential (ODP). Exemplary zero ODP blowing agents include HFC-245fa and cyclopentane (Cp). Cyclopentane has much lower global warming potential (GWP) than HFC-245fa, but the insulation performance of foams produced with Cp have been unable to meet requirements for energy efficiency. Compatibility of 4th generation blowing agents such as hydrofluoroolefins (HFOs) and their blends with refrigerator liner materials has seen limited development for appliance application. Accordingly, the present application provides exemplary HFOs and other zero ODP blowing agents for use as foam blowing agents (i.e., foam expansion agents or foam blowing components) in foamable compositions.

### Definitions and Abbreviations

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100-year time horizon is commonly the value referenced.

As used herein the term “Ozone depletion potential” (ODP) is defined in “The Scientific Assessment of Ozone Depletion, 2002, A report of the World Meteorological Association's Global Ozone Research and Monitoring Project,” section 1.4.4, pages 1.28 to 1.31 (see first paragraph of this section). ODP represents the extent of ozone depletion in the stratosphere expected from a compound on a mass-for-mass basis relative to fluorotrichloromethane (CFC-11).

### Chemicals, Abbreviations, and Acronyms

ABS: acrylonitrile butadiene styrene

Cp: cyclopentane

CFC: chlorofluorocarbon

CFC-11: trichlorofluoromethane

CFC-12: dichlorodifluoromethane

FEA: foam expansion agent

HCFC: hydrochlorofluorocarbons

HCFC-22: chlorodifluoromethane

HCFC-141b or 141b: 1,1-dichloro-1-fluoroethane

HCFC-142b or 142b: 1-chloro-1,1-difluoroethane

HFC: hydrofluorocarbons

HFC-152a or 152a: 1,1-difluoroethane

HFC-245fa or 245fa: pentafluoropropane

HFO: hydrofluoroolefin

HFO-1336mzz(Z) or 1336mzz-Z: (Z)-1,1,1,4,4,4-hexafluoro-2-butene

HFO-1336mzz(E) or 1336mzz-E: (E)-1,1,1,4,4,4-hexafluoro-2-butene

HFO-1233zd or 1233zd: 1-chloro-3,3,3-trifluoropropene

HIPS: high impact polystyrene

### Compositions

The present application provides a composition, comprising:

i) a foam blowing component comprising a compound selected from the group consisting of (Z)-1,1,1,4,4,4-hexafluoro-2-butene, (E)-1,1,1,4,4,4-hexafluoro-2-butene, 1,1,1,3,3-pentafluoropropane, and 1-chloro-3,3,3-trifluoropropene, or any mixture thereof; and

ii) a polymer component selected from polystyrene and acrylonitrile butadiene styrene.

In some embodiments, the foam blowing component does not consist of only (Z)-1,1,1,4,4,4-hexafluoro-2-butene.

In some embodiments, the foam blowing component comprises a compound selected from the group consisting of (E)-1,1,1,4,4,4-hexafluoro-2-butene, 1,1,1,3,3-pentafluoropropane, and 1-chloro-3,3,3-trifluoropropene, or any mixture thereof; or a mixture of (Z)-1,1,1,4,4,4-hexafluoro-2-butene and one or more compounds selected from the group consisting of (E)-1,1,1,4,4,4-hexafluoro-2-butene, 1,1,1,3,3-pentafluoropropane, and 1-chloro-3,3,3-trifluoropropene.

The present application further provides a composition comprising:

i) a foam blowing component comprising a compound selected from (E)-1,1,1,4,4,4-hexafluoro-2-butene and 1,1,1,3,3-pentafluoropropane, or any mixture thereof; and

ii) a polymer component selected from polystyrene and acrylonitrile butadiene styrene.

The present application further provides a composition comprising:

i) a foam blowing component comprising a compound which is (Z)-1,1,1,4,4,4-hexafluoro-2-butene and a compound selected from the group consisting of (E)-1,1,1,4,4,4-hexafluoro-2-butene, 1,1,1,3,3-pentafluoropropane, and 1-chloro-3,3,3-trifluoropropene; and

ii) a polymer component selected from polystyrene and acrylonitrile butadiene styrene.

In some embodiments, the compositions provided herein are foamable composition (i.e., compositions capable of reacting and/or foaming under conditions suitable for forming a foam).

In some embodiments, the compositions provided herein comprise a polymer component which is polystyrene. In some embodiments, the polystyrene is high impact polystyrene (HIPS). In some embodiments, the polymer component consists of high impact polystyrene. In some embodiments, the compositions provided herein comprise a polymer component which is acrylonitrile butadiene styrene (ABS). In some embodiments, the polymer component consists of acrylonitrile butadiene styrene.

In some embodiments, the compositions provided herein comprise a foam blowing component comprising (E)-1,1,1,4,4,4-hexafluoro-2-butene. In some embodiments, the foam blowing component consists of (E)-1,1,1,4,4,4-hexafluoro-2-butene.

In some embodiments, the compositions provided herein comprise a foam blowing component comprising 1,1,1,3,3-pentafluoropropane. In some embodiments, the foam blowing component consists of 1,1,1,3,3-pentafluoropropane.

In some embodiments, the compositions provided herein comprise a foam blowing component comprising (Z)-1,1,1,4,4,4-hexafluoro-2-butene.

In some embodiments, the compositions provided herein comprise a foam blowing component comprising a mixture of (Z)-1,1,1,4,4,4-hexafluoro-2-butene and (E)-1,1,1,4,4,4-hexafluoro-2-butene. In some embodiments, the foam blowing component consists of a mixture of (Z)-1,1,1,4,4,4-hexafluoro-2-butene and (E)-1,1,1,4,4,4-hexafluoro-2-butene.

In some embodiments, the foam blowing component comprises a mixture of about 0.1% to about 99.9% by weight (Z)-1,1,1,4,4,4-hexafluoro-2-butene and about 99.9% to about 0.1% by weight (E)-1,1,1,4,4,4-hexafluoro-2-butene, for example, about 1% by weight (Z)-1,1,1,4,4,4-hexafluoro-2-butene and about 99% by weight (E)-1,1,1,4,4,4-hexafluoro-2-butene, about 10% by weight (Z)-1,1,1,4,4,4-hexafluoro-2-butene and about 90% by weight (E)-1,1,1,4,4,4-hexafluoro-2-butene, about 25% by weight (Z)-1,1,1,4,4,4-hexafluoro-2-butene and about 75% by weight (E)-1,1,1,4,4,4-hexafluoro-2-butene, about 50% by weight (Z)-1,1,1,4,4,4-hexafluoro-2-butene and about 50% by weight (E)-1,1,1,4,4,4-hexafluoro-2-butene, about 75% by weight (Z)-1,1,1,4,4,4-hexafluoro-2-butene and about 25% by weight (E)-1,1,1,4,4,4-hexafluoro-2-butene, about 90% by weight (Z)-1,1,1,4,4,4-hexafluoro-2-butene and about 10% by weight (E)-1,1,1,4,4,4-hexafluoro-2-butene, or about 99% by weight (Z)-1,1,1,4,4,4-hexafluoro-2-butene and about 1% by weight (E)-1,1,1,4,4,4-hexafluoro-2-butene.

In some embodiments, the foam blowing component comprises a mixture of about 40% to about 60% by weight (Z)-1,1,1,4,4,4-hexafluoro-2-butene and about 40% to about 60% by weight (E)-1,1,1,4,4,4-hexafluoro-2-butene. In some embodiments, the foam blowing component comprises a mixture of about 50% by weight (Z)-1,1,1,4,4,4-hexafluoro-2-butene and about 50% by weight (E)-1,1,1,4,4,4-hexafluoro-2-butene.

In some embodiments, the compositions provided herein comprise a foam blowing component comprising a mixture of (Z)-1,1,1,4,4,4-hexafluoro-2-butene and 1,1,1,3,3-pentafluoropropane. In some embodiments, foam blowing component consists of a mixture of (Z)-1,1,1,4,4,4-hexafluoro-2-butene and 1,1,1,3,3-pentafluoropropane.

In some embodiments, the foam blowing component comprises a mixture of about 0.1% to about 99.9% by weight (Z)-1,1,1,4,4,4-hexafluoro-2-butene and about 99.9% to about 0.1% by weight 1,1,1,3,3-pentafluoropropane, for example, about 1% by weight (Z)-1,1,1,4,4,4-hexafluoro-2-butene and about 99% by weight 1,1,1,3,3-pentafluoropropane, about 10% by weight (Z)-1,1,1,4,4,4-hexafluoro-2-butene and about 90% by weight 1,1,1,3,3-pentafluoropropane, about 25% by weight (Z)-1,1,1,4,4,4-hexafluoro-2-butene and about 75% by weight 1,1,1,3,3-pentafluoropropane, about 50% by weight (Z)-1,1,1,4,4,4-hexafluoro-2-butene and about 50% by weight 1,1,1,3,3-pentafluoropropane, about 75% by weight (Z)-1,1,1,4,4,4-hexafluoro-2-butene and about 25% by weight 1,1,1,3,3-pentafluoropropane, about 90% by weight (Z)-1,1,1,4,4,4-hexafluoro-2-butene and about 10% by weight 1,1,1,3,3-pentafluoropropane, or about 99% by weight (Z)-1,1,1,4,4,4-hexafluoro-2-butene and about 1% by weight 1,1,1,3,3-pentafluoropropane.

In some embodiments, the foam blowing composition comprises a mixture of about 40% to about 60% by weight (Z)-1,1,1,4,4,4-hexafluoro-2-butene and about 40% to about 60% by weight 1,1,1,3,3-pentafluoropropane. In some embodiments, the foam blowing composition comprises a mixture of about 50% (Z)-1,1,1,4,4,4-hexafluoro-2-butene and 50% by weight 1,1,1,3,3-pentafluoropropane.

In some embodiments, the compositions provided herein comprise a foam blowing component comprising a mixture of (Z)-1,1,1,4,4,4-hexafluoro-2-butene and 1-chloro-3,3,3-trifluoropropene.

In some embodiments, the foam blowing component comprises a mixture of about 0.1% to about 99.9% by weight (Z)-1,1,1,4,4,4-hexafluoro-2-butene and about 99.9% to about 0.1% by weight 1-chloro-3,3,3-trifluoropropene, for example, about 1% by weight (Z)-1,1,1,4,4,4-hexafluoro-2-butene and about 99% by weight 1-chloro-3,3,3-trifluoropropene, about 10% by weight (Z)-1,1,1,4,4,4-hexafluoro-2-butene and about 90% by weight 1-chloro-3,3,3-trifluoropropene, about 25% by weight (Z)-1,1,1,4,4,4-hexafluoro-2-butene and about 75% by weight 1-chloro-3,3,3-trifluoropropene, about 50% by weight (Z)-1,1,1,4,4,4-hexafluoro-2-butene and about 50% by weight 1-chloro-3,3,3-trifluoropropene, about 75% by weight (Z)-1,1,1,4,4,4-hexafluoro-2-butene and about 25% by weight 1-chloro-3,3,3-trifluoropropene, about 90% by weight (Z)-1,1,1,4,4,4-hexafluoro-2-butene and about 10% by weight 1-chloro-3,3,3-trifluoropropene, or about 99% by weight (Z)-1,1,1,4,4,4-hexafluoro-2-butene and about 1% by weight 1-chloro-3,3,3-trifluoropropene.

In some embodiments, the foam blowing component comprises a mixture of about 40% to about 60% by weight (Z)-1,1,1,4,4,4-hexafluoro-2-butene and about 40% to about 60% by weight 1-chloro-3,3,3-trifluoropropene. In some embodiments, the foam blowing component comprises a mixture of 50% by weight (Z)-1,1,1,4,4,4-hexafluoro-2-butene and about 50% by weight 1-chloro-3,3,3-trifluoropropene.

In some embodiments, the compositions provided herein comprise:

a foam blowing component which is (E)-1,1,1,4,4,4-hexafluoro-2-butene, and a polymer component which is high impact polystyrene; or

a foam blowing component which is 1,1,1,3,3-pentafluoropropane, and a polymer component which is high impact polystyrene; or

a foam blowing component which is (E)-1,1,1,4,4,4-hexafluoro-2-butene, and a polymer component which is acrylonitrile butadiene styrene; or

a foam blowing component which is 1,1,1,3,3-pentafluoropropane, and a polymer component which is acrylonitrile butadiene styrene;

a foam blowing component which is a mixture of (Z)-1,1,1,4,4,4-hexafluoro-2-butene and (E)-1,1,1,4,4,4-hexafluoro-2-butene, and a polymer component which is high impact polystyrene; or

a foam blowing component which is a mixture of (Z)-1,1,1,4,4,4-hexafluoro-2-butene and 1,1,1,3,3-pentafluoropropane, and a polymer component which is high impact polystyrene;

a foam blowing component which is a mixture of (Z)-1,1,1,4,4,4-hexafluoro-2-butene and 1-chloro-3,3,3-trifluoropropene, and a polymer component which is high impact polystyrene; or

a foam blowing component which is a mixture of (Z)-1,1,1,4,4,4-hexafluoro-2-butene and (E)-1,1,1,4,4,4-hexafluoro-2-butene, and a polymer component which is acrylonitrile butadiene styrene; or

a foam blowing component which is a mixture of (Z)-1,1,1,4,4,4-hexafluoro-2-butene and 1,1,1,3,3-pentafluoropropane, and a polymer component which is acrylonitrile butadiene styrene; or

a foam blowing component which is a mixture of (Z)-1,1,1,4,4,4-hexafluoro-2-butene and 1-chloro-3,3,3-trifluoropropene, and a polymer component which is acrylonitrile butadiene styrene.

In some embodiments, the compositions provided herein comprise:

a foam blowing component which is a mixture of about 50% by weight (Z)-1,1,1,4,4,4-hexafluoro-2-butene and about 50% by weight (E)-1,1,1,4,4,4-hexafluoro-2-butene, and a polymer component which is high impact polystyrene; or

a foam blowing component which is a mixture of about 50% by weight (Z)-1,1,1,4,4,4-hexafluoro-2-butene and about 50% by weight 1,1,1,3,3-pentafluoropropane, and a polymer component which is high impact polystyrene;

a foam blowing component which is a mixture of about 50% by weight (Z)-1,1,1,4,4,4-hexafluoro-2-butene and about 50% by weight 1-chloro-3,3,3-trifluoropropene, and a polymer component which is high impact polystyrene; or

a foam blowing component which is a mixture of about 50% by weight (Z)-1,1,1,4,4,4-hexafluoro-2-butene and about 50% by weight (E)-1,1,1,4,4,4-hexafluoro-2-butene, and a polymer component which is acrylonitrile butadiene styrene; or

a foam blowing component which is a mixture of about 50% by weight (Z)-1,1,1,4,4,4-hexafluoro-2-butene and about 50% by weight 1,1,1,3,3-pentafluoropropane, and a polymer component which is acrylonitrile butadiene styrene; or

a foam blowing component which is a mixture of about 50% by weight (Z)-1,1,1,4,4,4-hexafluoro-2-butene and about 50% by weight 1-chloro-3,3,3-trifluoropropene, and a polymer component which is acrylonitrile butadiene styrene.

In some embodiments, the compositions provided herein further comprise n-pentane or iso-pentane. In some embodiments, the compositions consist of a foam blowing component described herein, a polymer component described herein, and n-pentane. In some embodiments, the compositions consist of a foam blowing component described herein, a polymer component described herein, and iso-pentane.

In some embodiments, the compositions provided herein are substantially free of cyclopentane. As used herein, a composition which is “substantially free” of cyclopentane refers to a composition containing, for example, less than about 5% of cyclopentane, less than about 4%, less than about 3%, less than about 2%, less than about 1%, less than about 0.5%, less than about 0.1%, or less than about 0.01% of cyclopentane. In some embodiments, the compositions provided herein are free of cyclopentane (i.e., the compositions contain no measurable amount of cyclopentane).

In some embodiments, the compositions provided herein comprise one or more additional ingredients. Exemplary additional ingredients include, but are not limited to, catalysts, surfactants, flame retardants, preservatives, colorants, antioxidants, reinforcing agents, fillers, antistatic agents, solubilizing agents, IR attenuating agents, nucleating agents, cell controlling agents, extrusion aids, stabilizing agents, thermally insulating agents, plasticizers, viscosity modifiers, impact modifiers, gas barrier resins, polymer modifiers, rheology modifiers, antibacterial agents, vapor pressure modifiers, UV absorbers, cross-linking agents, permeability modifiers, bitterants, propellants, and the like.

For example, when preparing a foam from a foamable composition provided herein, it may be preferable to incorporate a minor amount of a surfactant to stabilize the foaming reaction mixture until it cures. Such surfactants may comprise, for example, a liquid or solid organosilicone compound. Other surfactants include, but are not limited to, polyethylene glycol ethers of long chain alcohols, tertiary amine or alkanolamine salts of long chain alkyl acid sulfate esters, alkyl sulfonic esters and alkyl arylsulfonic acids. The surfactants are employed in amounts sufficient to stabilize the foaming reaction mixture against collapse and to prevent the formation of large, uneven cells. About 0.2 to about 5 parts or even more of the surfactant per 100 parts by weight of polymer component are usually sufficient.

In some embodiments, the compositions provided herein further comprise one or more nucleating agents. Nucleating agents serve primarily to increase cell count and decrease cell size in the foam, and may be used in an amount of about 0.1 to about 10 parts by weight per 100 parts by weight of the polymer component. Typical nucleating agents comprise at least one member selected from the group consisting of talc, sodium bicarbonate-citric acid mixtures, calcium silicate, carbon dioxide, among others.

In some embodiments, the compositions provided herein consist essentially of the foam blowing component and the polymer component. In some embodiments, the compositions provided herein consist of the foam blowing component and the polymer component. In some embodiments, the foam blowing component provided herein is substantially insoluble in the polymer component.

In some embodiments, the compositions (e.g., the foamable compositions) provided herein comprise about 5% to about 15% by weight foam blowing component based on the total weight of the composition (e.g., the total weight of the foam blowing component and the polymer component), for example, about 5% to about 12%, about 5% to about 10%, about 5% to about 8%, about 8% to about 15%, about 8% to about 12%, about 8% to about 10%, about 10% to about 15%, or about 10% to about 12% by weight. In some embodiments, the compositions comprise about 8% to about 10% by weight foam blowing component based on the total weight of the composition. It is understood that the proper amount of foam blowing component agent or resultant characteristics of the foam for any desired end-use can be readily determined by a skilled person in this art.

In some embodiments, the compositions (e.g., the foamable compositions) provided herein comprise about 95% to about 85% by weight polymer component based on the total weight of the composition (e.g., the total weight of the foam blowing component and the polymer component), for example, about 95% to about 88%, about 95% to about 90%, about 95% to about 92%, about 92% to about 85%, about 92% to about 88%, about 92% to about 90%, about 90% to about 85%, about 90% to about 88%, or about 88% to about 85%. In some embodiments, the compositions comprise about 90% to about 92% by weight polymer component based on the total weight of the composition.

### Foams and Methods of Preparing Foams

As described herein, the compositions of the present application may be useful as foam blowing compositions, for example, for preparing thermoset or thermoplastic foams. Any of a wide range of conventional methods for blowing such foams can be adapted for use herein.

Accordingly, the present application provides methods of forming a foam, comprising reacting or extruding a composition provided herein under conditions effective to form a foam. Methods of forming foams are well known in the art, such as those described in “Polyurethanes Chemistry and Technology,” Volumes I and II, Saunders and Frisch, 1962, John Wiley and Sons, New York, N.Y., the disclosure of which is incorporated herein by reference, and may be used or adapted for use in accordance with the compositions described herein.

Thus, in some embodiments, the present application provides methods of preparing a closed cell foam, comprising reacting or extruding a composition provided herein under conditions effective to form the closed cell foam. In some embodiments, the present application provides methods of preparing a thermoset foam, comprising reacting or extruding a composition provided herein under conditions effective to form the thermoset foam. In some embodiments, the present application provides methods of preparing a thermoplastic foam, comprising reacting or extruding a composition provided herein under conditions effective to form the thermoplastic foam.

The present application further provides processes of forming a thermoplastic foamable composition provided herein, comprising the steps of: (a) melting a polymer component described herein to form a melt; and (b) blending the foam blowing component with the melt to form a composition provided herein at a nonfoaming temperature and pressure as a plasticized melt.

The present application further provides methods of preparing a thermoplastic foam, comprising (a) melting a polymer component provided herein; (b) homogeneously blending a foam blowing component provided herein with the melt to form a plasticized mass at nonfoaming temperatures and pressures; (c) passing the plasticized mass at a controlled rate, temperature, and pressure through a die having a desired shape, e.g., slit die for producing rectangular slabs of foam board having desired thickness and surface area, into an expansion zone; (d) allowing the extrudate to foam in the expansion zone maintainable at suitable temperatures and low pressures; (e) maintaining the expanding extrudate under such temperatures and pressures for a time sufficient for the viscosity of the extrudate to increase such that the cell size and density of the foam remain substantially unchanged and substantially free of ruptured cells at ambient temperature; e.g., 25° C. and atmospheric pressure; and (f) recovering the extruded foam.

In some embodiments, the polymer component is melted at a temperature of about 200° C. to about 235° C. depending upon the grade employed, and at nonfoaming pressures of about 600 psig or higher. In some embodiments, the plasticized composition is cooled under nonfoaming pressure to a temperature of about 115° C. to 150° C. (e.g., 130° C.), and extruded into the expansion zone at or below ambient temperature and at or below atmospheric pressure.

The present application further provides foams are prepared according to one or more of the methods described herein. In some embodiments, the foam is a closed cell foam. In some embodiments, the foam is a thermoset foam. In some embodiments, the foam is a thermoplastic foam.

In some embodiments, the foam has an overall density of from about 10 kg/m³ to about 500 kg/m³, for example, about 10 kg/m³ to about 400 kg/m³, about 10 kg/m³ to about 300 kg/m³, about 10 kg/m³ to about 200 kg/m³, about 10 kg/m³ to about 100 kg/m³, about 10 kg/m³ to about 50 kg/m³, about 50 kg/m³ to about 500 kg/m³, about 50 kg/m³ to about 400 kg/m³, about 50 kg/m³ to about 300 kg/m³, about 50 kg/m³ to about 200 kg/m³, about 50 kg/m³ to about 100 kg/m³, about 100 kg/m³ to about 500 kg/m³, about 100 kg/m³ to about 400 kg/m³, about 100 kg/m³ to about 300 kg/m³, about 100 kg/m³ to about 200 kg/m³, about 200 kg/m³ to about 500 kg/m³, about 200 kg/m³ to about 400 kg/m³, about 200 kg/m³ to about 300 kg/m³, about 300 kg/m³ to about 500 kg/m³, about 300 kg/m³ to about 400 kg/m³, or about 400 kg/m³ to about 500 kg/m³,

In some embodiments, the cell size of the foam, excluding voids, is from about 20 μm to about 500 μm, for example, 20 μm to about 400 μm, 20 μm to about 300 μm, 20 μm to about 200 μm, 20 μm to about 100 μm, 20 μm to about 75 μm, 20 μm to about 50 μm, 50 μm to about 500 μm, 50 μm to about 400 μm, 50 μm to about 300 μm, 50 μm to about 200 μm, 50 μm to about 100 μm, 50 μm to about 75 μm, 75 μm to about 500 μm, 75 μm to about 400 μm, 75 μm to about 300 μm, 75 μm to about 200 μm, 75 μm to about 100 μm, 100 μm to about 500 μm, 100 μm to about 400 μm, 100 μm to about 300 μm, 100 μm to about 200 μm, 200 μm to about 500 μm, 200 μm to about 400 μm, 200 μm to about 300 μm, 300 μm to about 500 μm, 300 μm to about 400 μm, or about 400 μm to about 500 μm.

Representative foamed products that can be prepared in accordance with the methods provided herein include but are not limited to: (1) polystyrene foam sheet for the production of disposable thermoformed packaging materials; e.g., as disclosed in York, U.S. Pat. No. 5,204,169; (2) extruded polystyrene foam boards for use as residential and industrial sheathing and roofing materials, which may be from about 0.5 to 6 inches (1.25 to 15 cm) thick, up to 4 feet (122 cm) wide, with cross-sectional areas of from 0.17 to 3 square feet (0.016 to 0.28 square meter), and up to 27 feet (813 meters) long, with densities of from about 1.5 to 10 pounds per cubic foot (pcf) (25 to 160 kilograms per cubic meter (kg/m³); (3) expandable foams in the form of large billets which may be up to about 2 feet (61 cm) thick, often at least 1.5 feet 46 cm) thick, up to 4 feet (1.22 meters) wide, up to 16 feet (4.8 meters) long, having a cross-sectional area of about 2 to 8 square feet (0.19 to 0.74 square meter) and a density of from 6 to 15 pcf (96 to 240 kg/m³). Such foamed products are more fully described by Stockdopole and Welsh in the Encyclopedia of Polymer Science and Engineering, vol. 16, pages 193-205, John Wiley & Sons, 1989; the disclosure of which is incorporated by reference herein in its entirety.

The present application further provides methods of insulating an apparatus, comprising applying a composition provided herein onto one or more surfaces of the apparatus. Any of a wide range of conventional methods for applying (i.e., blowing) the compositions provided herein can be adapted for use herein.

In some embodiments, the apparatus is selected from the group consisting of a portable cooler (e.g., a picnic cooler), a refrigerator, a freezer, a refrigerated vehicle, and a refrigerated storage tank.

The present application further provides a coated apparatus, wherein the apparatus is coated with a composition provided herein. In some embodiments, the coated apparatus is an insulated apparatus, wherein the coating insulates the apparatus. In some embodiments, the coating is applied to one or more surfaces of the apparatus. In some embodiments, the coated apparatus is selected from the group consisting of a coated portable cooler (e.g., a coated picnic cooler), a coated refrigerator, a coated freezer, a coated refrigerated vehicle, and a coated refrigerated storage tank.

### EXAMPLES

The invention will be described in greater detail by way of specific examples. The following examples are offered for illustrative purposes, and are not intended to limit the invention in any manner. Those of skill in the art will readily recognize a variety of non-critical parameters which can be changed or modified to yield essentially the same results.

### Example 1. Compatibility Testing of Foam Expansion Agents with HIPS or ABS at Room Temperature

Samples of acrylonitrile butadiene styrene (ABS) from three different sources and high impact polystyrene (HIPS) from two different sources were immersed in various FEA and FEA blends in a bottle for 2 weeks at room temperature. Changes in weight, dimension, and hardness of the polymer were evaluated before and after exposure to the fluorinated compound. Hardness was measured using ASTM method D2240 for elastomers and plastics. The following general procedure was performed for each compatibility test:

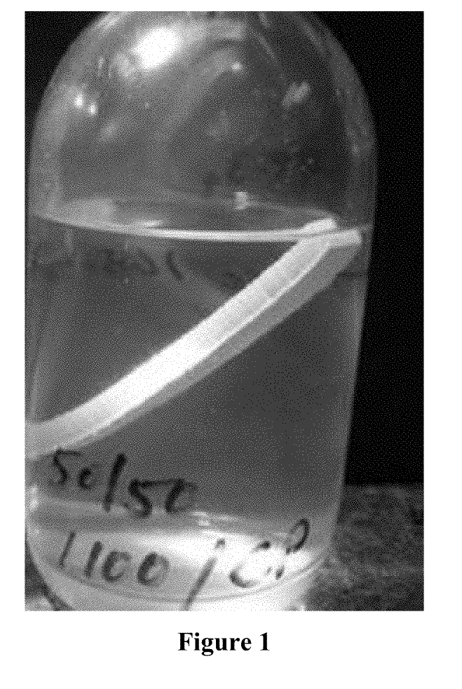

Bottles were labeled and initial hardness weight, height, width, and length were measured & recorded. Aerosol bottles with crimped caps were used for compatibility tests involving high pressure liquefied gases. Aerosol bottles were substituted with standard vials with screw caps if the vapor pressure was nominal. After the polymer sample was placed in the bottle, the sample was completely submerged with a foam expansion agent (FEA) (e.g., HFO, HFC, or blend of HFO/HFC) to be tested and the bottle was sealed (FIG. 1). When aerosol bottles were used with liquefied gases, the polymer sample was first placed in the bottle prior to a crimping cap, then the bottle was charged liquefied gas through a burette charging station. Each sealed bottle containing the polymer sample and liquid were then weighed and the bottles were maintained at room temperature for two weeks. Each bottle was reweighed after 24 hours to confirm that none were leaking. After two weeks, the bottles were opened and the hardness of each polymer sample was measured and any changes from the initial measurements of the polymer sample were calculated. The polymer samples were then maintained in ambient atmosphere for an additional two weeks to allow any absorbed liquid to evaporate, at which time the hardness of the polymer sample was re-measured.

Compatibility of the liquid and polymer sample were analyzed according to the parameters shown below in Tables A-B. Compatibility ratings and physical changes for FEA/polymer samples are shown below in Tables 1-8.

TABLE A
Compatibility Rating
0 = Best; when weight gain <1 and physical change = 1
1 = Borderline; when weight gain >1 and <10 or physical change = 2
2 = Worst; when weight gain >10 or physical change = 3
Physical Change
1 = No change
2 = Surface change (dulled or crazed)
3 = Destroyed or dissolved

TABLE B

| Rating | % Linear Swell | | Δ Hardness |
|---|---|---|---|
| 0—Compatible | ≤10 | and | ≤10 |
| 1—Borderline | >10 | or | >10 |
| 2—Incompatible | >10 | and | >10 |

Data showing changes in HIPS or ABS samples submerged in FEAs or FEA blends are shown in Tables 1-8. FEAs and FEA blends that caused less than ±10% changes were considered to show good liner compatibility.

TABLE 1
Changes of ABS Sample 1 in Pure FEAs

| Foam | % | % | % | % | % | % | | |
|---|---|---|---|---|---|---|---|---|
| Expansion | weight | volume | width | thickness | length | hardness | | |
| Agent | gain | gain | change | change | change | change | A | B |
| 1336mzz-E | 0% | 2.3% | 1% | 1% | 0% | 0% | 0 | 1 |
| 1336mzz-Z | −5% | 6% | −2% | 8% | 0% | 0% | 0 | 1 |
| 1233zd | 24% | 24% | 8% | 14% | 1% | 0% | 2 | 1 |
| HFC245fa | 0% | 4.2% | 1% | 3% | 0% | 0% | 2 | 1 |
| Cp | 14% | 25% | 7% | 10% | 6% | 0% | 2 | 1 |
| HCFC-141b | −100% | −100% | −100% | −100% | −100% | −100% | 2 | 3 |

A: Compatibility Rating
B. Physical Changes

TABLE 2
Changes of ABS Sample 2 in Pure FEAs

| Foam | % | % | % | % | % | % | | |
|---|---|---|---|---|---|---|---|---|
| Expansion | weight | volume | width | thickness | length | hardness | | |
| Agent | gain | gain | change | change | change | change | A | B |
| 1336mzz-Z | 0% | 0.2% | 0% | 0% | 0% | 5% | 0 | 1 |
| 1233zd | 10% | 9.2% | 3% | 6% | 0% | −1% | 1 | 1 |
| Cp | 4% | 7% | 1% | 6% | −1% | 5% | 1 | 1 |

A: Compatibility Rating
B. Physical Changes

TABLE 3
Changes of ABS Sample 1 in FEA Blends

| Foam | % | % | % | % | % | % | | |
|---|---|---|---|---|---|---|---|---|
| Expansion | weight | volume | width | thickness | length | hardness | | |
| Agent | gain | gain | change | change | change | change | A | B |
| 50/50 1336mzz-Z/ | 3% | 9% | 1% | 7% | 0% | N/A | 1 | 1 |
| 1233zd | | | | | | | | |
| 50/50 1336mzz-Z/ | 0% | 6% | 2% | 4% | 0% | 0% | 0 | 1 |
| 1336mzz-E | | | | | | | | |
| 50/50 HFC-245fa/ | 0% | 4% | 2% | 2% | 0% | 0% | 0 | 1 |
| 1336mzzZ | | | | | | | | |
| 50/50 HFC-245fa/ | 107% | 119% | 13% | 77% | 10% | −4% | 2 | 2 |
| CP | | | | | | | | |
| 50/50 1336mzzZ/ | 74% | 98% | 14% | 49% | 16% | 0% | 2 | 2 |
| Cp | | | | | | | | |
| 50/50 1233zd/ | 53% | 65% | 13% | 33% | 10% | −2% | 2 | 2 |
| Cp | | | | | | | | |
| 1233zd/ | 68% | 80% | 12% | 46% | 10% | −2% | 2 | 2 |
| 1336mzz-Z/Cp | | | | | | | | |
| HFC-245fa/ | 73% | 81% | 12% | 47% | 10% | 0% | 2 | 2 |
| 1336mzz-Z/Cp | | | | | | | | |

A: Compatibility Rating
B. Physical Changes

TABLE 4
Changes of ABS Sample 2 in FEA Blends

| Foam | % | % | % | % | % | % | | |
|---|---|---|---|---|---|---|---|---|
| Expansion | weight | volume | width | thickness | length | hardness | | |
| Agent | gain | gain | change | change | change | change | A | B |
| 50/50 1336mzz-Z/ | 2% | 2% | 0% | 2% | 0% | 5% | 1 | 1 |
| 1233zd | | | | | | | | |
| 50/50 245fa/ | 71% | 86% | 26% | 70% | −13% | −59% | 2 | 2 |
| Cp | | | | | | | | |
| 50/50 1336mzz-Z/ | 45% | 61% | 17% | 31% | 5% | −1% | 1 | 1 |
| Cp | | | | | | | | |
| 50/50 1233zd/ | 26% | 29% | 8% | 18% | 2% | −1% | 2 | 1 |
| Cp | | | | | | | | |

A: Compatibility Rating
B. Physical Changes

TABLE 5
Changes of HIPS Sample 1 in Pure FEAs

| Foam | % | % | % | % | % | % | | |
|---|---|---|---|---|---|---|---|---|
| Expansion | weight | volume | width | thickness | length | hardness | | |
| Agent | gain | gain | change | change | change | change | A | B |
| 1336mzz-E | 0% | −13% | 0% | −13% | 0% | 2% | 1 | 2 |
| 1336mzz-Z | 0% | 4% | 1% | 3% | 0% | 5% | 0 | 2 |
| 1233zd | 62% | 89% | −12% | 111% | 2% | −43% | 2 | 3 |
| 245fa | −5% | −14% | 0% | −3% | −11% | 2% | 2 | 3 |
| Cp | −100% | −100% | −100% | −100% | −100% | −100% | 2 | 3 |
| 141b | −100% | −100% | −100% | −100% | −100% | −100% | 2 | 3 |

A: Compatibility Rating
B. Physical Changes

TABLE 6
Changes of HIPS Sample 2 in Pure FEAs

| Foam | % | % | % | % | % | % | | |
|---|---|---|---|---|---|---|---|---|
| Expansion | weight | volume | width | thickness | length | hardness | | |
| Agent | gain | gain | change | change | change | change | A | B |
| 1336mzz-Z | 0% | 0% | 0% | 0% | 0% | 0% | 0 | 1 |
| 1233zd | 51% | 72% | 9% | 55% | 1% | −47% | 2 | 3 |
| Cp | −100% | −100% | −100% | −100% | −100% | NA | 2 | 3 |

A: Compatibility Rating
B. Physical Changes

TABLE 7
Changes of HIPS Sample 1 in FEA Blends

| Foam | % | % | % | % | % | % | | |
|---|---|---|---|---|---|---|---|---|
| Expansion | weight | volume | width | thickness | length | hardness | | |
| Agent | gain | gain | change | change | change | change | A | B |
| 50/50 1336mzz-Z/ | 3% | 0% | 1% | −1% | 0% | 1% | 0 | 1 |
| 1233zd | | | | | | | | |
| 50/50 1336mzz-Z/ | 0% | 2% | 1% | 1% | 0% | 5% | 0 | 1 |
| 1336mzz-E | | | | | | | | |
| 50/50 245fa/ | 0% | 11% | 1% | 10% | 0% | 2% | 1 | 2 |
| 1336mzz-Z | | | | | | | | |
| 50/50 1336mzz-Z/ | −100% | −100% | −100% | −100% | −100% | −100% | 2 | 3 |
| Cp | | | | | | | | |
| 50/50 1233zd/ | −100% | −100% | −100% | −100% | −100% | −100% | 2 | 3 |
| Cp | | | | | | | | |
| 50/50 245fa/ | −100% | −100% | −100% | −100% | −100% | −100% | 2 | 3 |
| CP | | | | | | | | |
| 1233zd/ | 47% | 8% | −1% | 24% | −12% | 0% | 2 | 3 |
| 1336mzz-Z/ | | | | | | | | |
| Cp | | | | | | | | |
| 245fa/ | −100% | −100% | −100% | −100% | −100% | −100% | 2 | 3 |
| 1336mzzZ/ | | | | | | | | |
| Cp | | | | | | | | |

A: Compatibility Rating
B. Physical Changes

TABLE 8
Changes of HIPS Sample 2 in FEA Blends

| Foam | % | % | % | % | % | % | | |
|---|---|---|---|---|---|---|---|---|
| Expansion | weight | volume | width | thickness | length | hardness | | |
| Agent | gain | gain | change | change | change | change | A | B |
| 50/50 | 3% | 3% | 1% | 2% | 0% | 2% | 0 | 1 |
| 1336mzz-Z/ | | | | | | | | |
| 1233zd | | | | | | | | |
| 50/50 | −100% | −100% | −100% | −100% | −100% | NA | 2 | 3 |
| 245fa/Cp | | | | | | | | |
| 50/50 | −100% | −100% | −100% | −100% | −100% | NA | 2 | 3 |
| 1336mzz-Z/ | | | | | | | | |
| Cp | | | | | | | | |
| 50/50 | −100% | −100% | −100% | −100% | −100% | NA | 2 | 3 |
| 1233zd/ | | | | | | | | |
| Cp | | | | | | | | |

A: Compatibility Rating
B. Physical Changes

Utilizing the criteria for compatibility described above and the changes shown in Tables 1-8, HFO-1233zd(E) and HCFC-141b were found to show poor compatibility with ABS and HIPS. In contrast, HFO-1336mzz(Z), HFO-1336mzz(E), and HFC-245fa unexpectedly show good compatibility with ABS and HIPS. It was also found that FEA blends with cyclopentane showed poor compatibility with HIPS and ABS, however, blends of HFO-1336mzz(Z)/HFO-1233zd(E), HFO-1336mzz(Z)/HFO-1336mzz(E) and HFO-1336mzz(Z)/HFC-245fa showed good compatibility.

The unexpectedly good compatibility of the FEAs and blends described above was also evidenced by low solubility between the polymer and the FEA. Having a mixture of foam blowing agent and polymer with low solubility is a useful parameter for preparing foams for use as insulation materials, such as refrigerator liners.

### OTHER EMBODIMENTS

1. A composition comprising:

i) a foam blowing component comprising a compound selected from (E)-1,1,1,4,4,4-hexafluoro-2-butene and 1,1,1,3,3-pentafluoropropane, or any mixture thereof; and

ii) a polymer component selected from polystyrene and acrylonitrile butadiene styrene.

2. A composition comprising:

i) a foam blowing component comprising a compound which is (Z)-1,1,1,4,4,4-hexafluoro-2-butene and a compound selected from (E)-1,1,1,4,4,4-hexafluoro-2-butene, 1,1,1,3,3-pentafluoropropane, and 1-chloro-3,3,3-trifluoropropene; and

ii) a polymer component selected from polystyrene and acrylonitrile butadiene styrene.

3. The composition of embodiment 1 or 2, wherein the polymer component is polystyrene.
4. The composition of embodiment 3, wherein the polystyrene is high impact polystyrene.
5. The composition of embodiment 1 or 2, wherein the polymer component is acrylonitrile butadiene styrene.
6. The composition of any one of embodiments 1 and 3 to 5, wherein the foam blowing component comprises (E)-1,1,1,4,4,4-hexafluoro-2-butene.
7. The composition of any one of embodiments 1 and 3 to 5, wherein the foam blowing component comprises 1,1,1,3,3-pentafluoropropane.
8. The composition of any one of embodiments 2 to 5, wherein the foam blowing component comprises a mixture of (Z)-1,1,1,4,4,4-hexafluoro-2-butene and (E)-1,1,1,4,4,4-hexafluoro-2-butene.
9. The composition of any one of embodiments 2 to 5 and 8, wherein the foam blowing component comprises a mixture of about 40% to about 60% by weight (Z)-1,1,1,4,4,4-hexafluoro-2-butene and about 40% to about 60% by weight (E)-1,1,1,4,4,4-hexafluoro-2-butene.
10. The composition of any one of embodiments 2 to 5, wherein the foam blowing component comprises a mixture of (Z)-1,1,1,4,4,4-hexafluoro-2-butene and 1,1,1,3,3-pentafluoropropane.
11. The composition of any one of embodiments 2 to 5 and 10, wherein the foam blowing component comprises a mixture of about 40% to about 60% by weight (Z)-1,1,1,4,4,4-hexafluoro-2-butene and about 40% to about 60% by weight 1,1,1,3,3-pentafluoropropane.
12. The composition of any one of embodiments 2 to 5, wherein the foam blowing component comprises a mixture of (Z)-1,1,1,4,4,4-hexafluoro-2-butene and 1-chloro-3,3,3-trifluoropropene.
13. The composition of any one of embodiments 2 to 5 and 12, wherein the foam blowing component comprises a mixture of about 40% to about 60% by weight (Z)-1,1,1,4,4,4-hexafluoro-2-butene and about 40% to about 60% by weight 1-chloro-3,3,3-trifluoropropene.
14. The composition of embodiment 1, wherein the composition comprises:

a foam blowing component which is (E)-1,1,1,4,4,4-hexafluoro-2-butene, and a polymer component which is high impact polystyrene; or

a foam blowing component which is 1,1,1,3,3-pentafluoropropane, and a polymer component which is high impact polystyrene; or

a foam blowing component which is (E)-1,1,1,4,4,4-hexafluoro-2-butene, and a polymer component which is acrylonitrile butadiene styrene; or

a foam blowing component which is 1,1,1,3,3-pentafluoropropane, and a polymer component which is acrylonitrile butadiene styrene.

15. The composition of embodiment 2, wherein the composition comprises:

a foam blowing component which is a mixture of (Z)-1,1,1,4,4,4-hexafluoro-2-butene and (E)-1,1,1,4,4,4-hexafluoro-2-butene, and a polymer component which is high impact polystyrene; or

a foam blowing component which is a mixture of (Z)-1,1,1,4,4,4-hexafluoro-2-butene and 1,1,1,3,3-pentafluoropropane, and a polymer component which is high impact polystyrene;

a foam blowing component which is a mixture of (Z)-1,1,1,4,4,4-hexafluoro-2-butene and 1-chloro-3,3,3-trifluoropropene, and a polymer component which is high impact polystyrene; or

a foam blowing component which is a mixture of (Z)-1,1,1,4,4,4-hexafluoro-2-butene and (E)-1,1,1,4,4,4-hexafluoro-2-butene, and a polymer component which is acrylonitrile butadiene styrene; or

a foam blowing component which is a mixture of (Z)-1,1,1,4,4,4-hexafluoro-2-butene and 1,1,1,3,3-pentafluoropropane, and a polymer component which is acrylonitrile butadiene styrene; or

a foam blowing component which is a mixture of (Z)-1,1,1,4,4,4-hexafluoro-2-butene and 1-chloro-3,3,3-trifluoropropene, and a polymer component which is acrylonitrile butadiene styrene.

16. The composition of any one of embodiments 1 to 15, wherein the composition further comprises n-pentane or iso-pentane.
17. The composition of any one of embodiments 1 to 16, wherein the composition consists of the foam blowing component, the polymer component, and n-pentane.
18. The composition of any one of embodiments 1 to 16, wherein the composition consists of the foam blowing component, the polymer component, and iso-pentane.
19. The composition of any one of embodiments 1 to 18, wherein the composition is substantially free of cyclopentane.
20. The composition of any one of embodiments 1 to 19, wherein the foam blowing component is substantially insoluble in the polymer component.
21. The composition of any one of embodiments 1 to 15, 19, and 20, wherein the composition consists of the foam blowing component and the polymer component.
22. The composition of any one of embodiments 1 to 21, wherein the composition comprises about 8% to about 10% by weight foam blowing component, based on the total weight of the foam blowing component and polymer component.
23. The composition of any one of embodiments 1 to 22, wherein the composition comprises about 92% to about 90% by weight polymer component, based on the total weight of the foam blowing component and polymer component.

24. The composition of any one of embodiments 1 to 23, wherein the composition is a foamable composition.

25. A method of forming a foam, comprising reacting or extruding a composition of any one of embodiments 1 to 24 under conditions effective to form a foam.
26. The method of embodiment 25, wherein the foam is a closed cell foam.

27. The method of embodiment 25 or 26, wherein the foam is a thermoset foam or a thermoplastic foam.

28. The method of any one of embodiments 25 to 27, wherein the foam has an overall density of from about 10 kg/m³ to about 500 kg/m³.
29. The method of any one of embodiments 25 to 28, wherein the cell size of the foam, excluding voids, is from about 200 μM to about 300 μM.
30. A method of insulating an apparatus, comprising applying a composition of any one of embodiments 1 to 24 onto one or more surfaces of the apparatus.
31. The method of embodiment 30, wherein the apparatus is selected from the group consisting of a refrigerator, a freezer, a refrigerated vehicle, a refrigerated storage tank.
32. A coated apparatus, wherein the apparatus is coated with a composition of any one of embodiments 1 to 24.
33. The coated apparatus of embodiment 32, wherein the coated apparatus is selected from the group consisting of a coated refrigerator, a coated freezer, a coated refrigerated vehicle, and a coated refrigerated storage tank.
34. A polystyrene foam, which is prepared according to the method of any one of embodiments 25 to 29.
35. The polystyrene foam of embodiment 34, wherein the polystyrene is high impact polystyrene.
36. An acrylonitrile butadiene styrene foam, which is prepared according to the method of any one of embodiments 25 to 29.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims. It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

What is claimed is:

1. A composition comprising:
i) a foam blowing component comprising a compound selected from (E)-1,1,1,4,4,4-hexafluoro-2-butene and 1,1,1,3,3-pentafluoropropane, or any mixture thereof; and
ii) a polymer component selected from polystyrene and acrylonitrile butadiene styrene.

2. A composition comprising:
i) a foam blowing component comprising a compound which is (Z)-1,1,1,4,4,4-hexafluoro-2-butene and a compound selected from (E)-1,1,1,4,4,4-hexafluoro-2-butene, 1,1,1,3,3-pentafluoropropane, and 1-chloro-3,3,3-trifluoropropene; and
ii) a polymer component selected from polystyrene and acrylonitrile butadiene styrene.

3. The composition of claim 1, wherein the polymer component is polystyrene.

4. The composition of claim 3, wherein the polystyrene is high impact polystyrene.

5. The composition of claim 1, wherein the polymer component is acrylonitrile butadiene styrene.

6. The composition of claim 1, wherein the foam blowing component comprises (E)-1,1,1,4,4,4-hexafluoro-2-butene.

7. The composition of claim 1, wherein the foam blowing component comprises 1,1,1,3,3-pentafluoropropane.

8. The composition of claim 2, wherein the foam blowing component comprises a mixture of (Z)-1,1,1,4,4,4-hexafluoro-2-butene and (E)-1,1,1,4,4,4-hexafluoro-2-butene.

9. The composition of claim 2, wherein the foam blowing component comprises a mixture of about 40% to about 60% by weight (Z)-1,1,1,4,4,4-hexafluoro-2-butene and about 40% to about 60% by weight (E)-1,1,1,4,4,4-hexafluoro-2-butene.

10. The composition of claim 2, wherein the foam blowing component comprises a mixture of (Z)-1,1,1,4,4,4-hexafluoro-2-butene and 1,1,1,3,3-pentafluoropropane.

11. The composition of claim 2, wherein the foam blowing component comprises a mixture of about 40% to about 60% by weight (Z)-1,1,1,4,4,4-hexafluoro-2-butene and about 40% to about 60% by weight 1,1,1,3,3-pentafluoropropane.

12. The composition of claim 2, wherein the foam blowing component comprises a mixture of (Z)-1,1,1,4,4,4-hexafluoro-2-butene and 1-chloro-3,3,3-trifluoropropene.

13. The composition of claim 2, wherein the foam blowing component comprises a mixture of about 40% to about 60% by weight (Z)-1,1,1,4,4,4-hexafluoro-2-butene and about 40% to about 60% by weight 1-chloro-3,3,3-trifluoropropene.

14. The composition of claim 1, wherein the composition comprises:
a foam blowing component which is (E)-1,1,1,4,4,4-hexafluoro-2-butene, and a polymer component which is high impact polystyrene; or
a foam blowing component which is 1,1,1,3,3-pentafluoropropane, and a polymer component which is high impact polystyrene; or
a foam blowing component which is (E)-1,1,1,4,4,4-hexafluoro-2-butene, and a polymer component which is acrylonitrile butadiene styrene; or
a foam blowing component which is 1,1,1,3,3-pentafluoropropane, and a polymer component which is acrylonitrile butadiene styrene.

15. The composition of claim 2, wherein the composition comprises:
a foam blowing component which is a mixture of (Z)-1,1,1,4,4,4-hexafluoro-2-butene and (E)-1,1,1,4,4,4-hexafluoro-2-butene, and a polymer component which is high impact polystyrene; or
a foam blowing component which is a mixture of (Z)-1,1,1,4,4,4-hexafluoro-2-butene and 1,1,1,3,3-pentafluoropropane, and a polymer component which is high impact polystyrene;
a foam blowing component which is a mixture of (Z)-1,1,1,4,4,4-hexafluoro-2-butene and 1-chloro-3,3,3-trifluoropropene, and a polymer component which is high impact polystyrene; or
a foam blowing component which is a mixture of (Z)-1,1,1,4,4,4-hexafluoro-2-butene and (E)-1,1,1,4,4,4-hexafluoro-2-butene, and a polymer component which is acrylonitrile butadiene styrene; or
a foam blowing component which is a mixture of (Z)-1,1,1,4,4,4-hexafluoro-2-butene and 1,1,1,3,3-pentafluoropropane, and a polymer component which is acrylonitrile butadiene styrene; or
a foam blowing component which is a mixture of (Z)-1,1,1,4,4,4-hexafluoro-2-butene and 1-chloro-3,3,3-trifluoropropene, and a polymer component which is acrylonitrile butadiene styrene.

16. The composition of claim 1, wherein the composition further comprises n-pentane or iso-pentane.

17. The composition of claim 1, wherein the composition consists of the foam blowing component, the polymer component, and n-pentane.

18. The composition of claim 1, wherein the composition consists of the foam blowing component, the polymer component, and iso-pentane.

19. The composition of claim 1, wherein the composition is substantially free of cyclopentane.

20. The composition of claim 1, wherein the foam blowing component is substantially insoluble in the polymer component.

21. The composition of claim 1, wherein the composition consists of the foam blowing component and the polymer component.

22. The composition of claim 1, wherein the composition comprises about 8% to about 10% by weight foam blowing component, based on the total weight of the foam blowing component and polymer component.

23. The composition of claim 1, wherein the composition comprises about 92% to about 90% by weight polymer component, based on the total weight of the foam blowing component and polymer component.

24. The composition of claim 1, wherein the composition is a foamable composition.

25. A method of forming a foam, comprising reacting or extruding a composition of claim 1 under conditions effective to form a foam.

26. The method of claim 25, wherein the foam is a closed cell foam.

27. The method of claim 25, wherein the foam is a thermoset foam or a thermoplastic foam.

28. The method of claim 1, wherein the foam has an overall density of from about 10 kg/m³ to about 500 kg/m³.

29. The method of claim 25, wherein the cell size of the foam, excluding voids, is from about 200 μM to about 300 μM.

30. A method of insulating an apparatus, comprising applying a composition of any claim 1 onto one or more surfaces of the apparatus.

31. The method of claim 30, wherein the apparatus is selected from the group consisting of a refrigerator, a freezer, a refrigerated vehicle, a refrigerated storage tank.

32. A coated apparatus, wherein the apparatus is coated with a composition of claim 1.

33. The coated apparatus of claim 32, wherein the coated apparatus is selected from the group consisting of a coated refrigerator, a coated freezer, a coated refrigerated vehicle, and a coated refrigerated storage tank.

34. A polystyrene foam, which is prepared according to the method of claim 25.

35. The polystyrene foam of claim 34, wherein the polystyrene is high impact polystyrene.

36. An acrylonitrile butadiene styrene foam, which is prepared according to the method of claim 25.
